(19) United States
(12) Patent Application Publication
(10) Pub. No.: US 2015/0163853 A1
(43) Pub. Date: Jun. 11, 2015

(54) MOBILE COMMUNICATION TERMINAL HAVING MULTIPLE COMMUNICATION INTERFACES, AND COOPERATIVE DATA COMMUNICATION METHOD THEREOF

(71) Applicant: Electronics and Telecommunications Research Institute, Daejeon-si (KR)

(72) Inventors: Min-Kyo IN, Daejeon-si (KR); Kang-Chan LEE, Daejeon-si (KR); Seung-Yun LEE, Daejeon-si (KR); Jong-Hong JEON, Daejeon-si (KR); Sung-Han KIM, Daejeon-si (KR)

(21) Appl. No.: 14/464,350

(22) Filed: Aug. 20, 2014

(30) Foreign Application Priority Data
Dec. 11, 2013 (KR) 10-2013-0153764

(51) Int. Cl. H04W 88/06; H04W 84/18; H04W 4/00

(52) U.S. Cl. CPC H04W 88/06; H04W 4/008; H04W 84/18

(57) ABSTRACT

Mobile devices, each having multiple communication interfaces, and a cooperative communication method thereof. Each of the mobile devices includes a mobile communication interface; a short range communication interface which is configured to communicate with different mobile devices over short range ad hoc network; an integrated network resource management module configured to control the mobile communication interface and the short range communication interface; and a data relay module configured to enable data transmission between the mobile communication interface, the short range communication interface, and the integrated network resource management module, wherein the integrated network resource management module is further configured to divide the data into first data fragment and second data fragment, control the mobile communication interface to receive the first data fragment over a cellular network, and control the short range interface to receive the second data fragment over the short range ad hoc network.

### CROSS-REFERENCE TO RELATED APPLICATION(S)

This application claims priority from Korean Patent Application No. 10-2013-0153764, filed on Dec. 11, 2013, in the Korean Intellectual Property Office, the entire disclosure of which is incorporated herein by reference for all purposes.

### BACKGROUND

1. Field

The following description relates to a technology by which a mobile device having multiple communication interfaces including a mobile communication interface cooperates with a different mobile device to perform data communication.

2. Description of the Related Art

Since conventional mobile devices are mostly feature phones for voice calls and text messages, they can perform communication with relatively narrow bandwidth. However, with the spread of smart phones and smart communication device, demands for high capacity data communication using a mobile device are growing. Thus, bandwidth of frequency supporting the data communication is increasing and telecommunication technologies have developed into 2G, 3G, and 4G.

Due to the spread of smart communication device and the development of telecommunication technologies, more and more people demand various services requiring greater bandwidth. For example, more download or stream services for high capacity files (e.g., videos and multimedia files) using a mobile device are increasingly demanded.

Such demands are backed up by the trend in which almost all mobile devices support high-capacity short range communication, such as Wi-Fi. Jumping on the bandwagon, a service that provides a data transfer rate exceeding a maximum data transfer rate supported by a cellular network has been introduced, but it cannot be used over the cellular network. In addition, although a service can be provided with a maximum data transfer rate supported by the cellular network, it is hard to meet consumer demand due to characteristics of the cellular network, such as the distance from a base station, a location of the base station, and surrounding environments, for example, a building that may obstruct mobile communications. Moreover, even when all situations are favorable for communications over a cellular network, excessive data communication causes costs to increase, thereby inevitably leading to great burden to users.

In order to resolve this drawback, the Korean Patent Publication No. 10-2010-0052025, titled “BANDWIDTH SHARING TYPE CONTENT PROVIDING SYSTEM AND METHOD”, was introduced to propose a method of utilizing idle bandwidth of a different mobile device. In this related art, when requesting and receiving content, a mobile device lacking in bandwidth may be given the idle bandwidth of a different previously registered mobile device to receive the content. That is, a mobile device may perform communication using both bandwidth of its own and wider bandwidth to which bandwidth for a different mobile device has been added.

However, the related art is based on the assumption that a mobile device having requested a service performs communication using both bandwidth of its own and bandwidth of a different mobile device. That is, the related art cannot perform communication using bandwidth greater than maximum bandwidth for a specific mobile device. In addition, the mobile device having requested a service receives the whole content, thereby increasing costs for communication.

### SUMMARY

The following description relates to a mobile device that has multiple communication interfaces, which is enabled to provide content of bandwidth greater than limited cellular network bandwidth and of a data transfer rate exceeding that of a cellular network.

The following description relates to a mobile device that has multiple communication interfaces and a cooperative data communication method of the mobile device, wherein the multiple communication interfaces can prevent increasing costs for data communication of a specific mobile device.

The following description relates to a mobile device that has multiple communication interfaces and a cooperative data communication method of the mobile device, wherein the mobile device cooperates with a plurality of mobile devices to receive a download or stream service for high-capacity content.

In one general aspect, there is provided a mobile device having multiple communication interfaces to receive data transmitted from a service server, the mobile device including: a mobile communication interface configured to perform data communication over a cellular network; one or more short range communication interfaces, each of which is configured to establish a short range ad hoc network with one or more different mobile devices and communicate with the different mobile devices over the short range ad hoc network; an integrated network resource management module configured to control the mobile communication interface and the one or more short range communication interfaces; and a data relay module configured to enable data transmission between the mobile communication interface, the one or more short range communication interfaces, and the integrated network resource management module, wherein the integrated network resource management module is further configured to divide the data into first data fragment and second data fragment, control the mobile communication interface to receive the first data fragment over the cellular network, and control the one or more short range interfaces to receive the second data fragment over the short range ad hoc network.

The integrated network resource management module may be further configured to divide the data based on a number of different mobile devices in the short range ad hoc network and on available bandwidth provided by each of the different mobile devices over the cellular network.

The integrated network resource management module may be further configured to comprise a device list manager configured to manage information on the different mobile devices; and a bandwidth manager configured to manage information on the available bandwidth provided by each of the different mobile devices over the cellular network, wherein the different mobile devices are managed by the device list manager.

The integrated network resource management module may be further configured to comprise a mobile communication manager configured to manage operations of the mobile communication interface; and a short range communication network manager configured to manage operations of the one or more short range communication interfaces.

The data relay module may be further configured to combine the first data fragment and the second data fragment, and transmit the combined data to an application.

In a case where there is a plurality of different mobile devices in the short range ad hoc network, the integrated network resource management module may be further configured to divide the second data fragment into a plurality of sub data fragment and control the one or more short range communication interfaces to receive the plurality of sub data fragment over the short range ad hoc network.

In response to a request for receipt of data from the second mobile device over the short range ad hoc network, the integrated network resource management module may be further configured to control the mobile communication interface to receive the requested data over the cellular network and transmit the requested data to the second mobile device over the short range ad hoc network.

The data relay module may be further configured to transmit the requested data to the short range communication interfaces.

In another general aspect, there is provided a cooperative communication method of mobile devices, each having a mobile communication interface and one or more short range communication interfaces, the method including: dividing data requested by an application into first data fragment to be received using the mobile communication interface, and second data fragments to be received using the one or more short range communication interfaces; controlling the mobile communication interface to request transmission of the first data fragment from a service server, and controlling the one or more short range interfaces to request transmission of the second data fragments from different mobile devices that have established a short range ad hoc network with the mobile device; and combining the first data fragment and the second data fragments, and transmitting the combined data fragment to the application.

An integrated network resource management module may divide the data based on a number of different mobile devices in the short range ad hoc networks and information on available bandwidth provided by each of the different mobile devices over a cellular network.

Other features and aspects may be apparent from the following detailed description, the drawings, and the claims.

### BRIEF DESCRIPTION OF THE DRAWINGS

FIG. 1 is a diagram illustrating a configuration of a service system for explanation of a mobile communication device having a multiple communication interface and a cooperative data transmission method thereof, according to an exemplary embodiment.

FIG. 2 is a block diagram illustrating a mobile devices illustrated in FIG. 1.

FIG. 3 is a diagram illustrating a detailed configuration of an integrated network resource management module shown in FIG. 2.

FIG. 4 is a diagram illustrating a cooperative data communication method of a mobile device having multiple communication interfaces, the mobile device of which is described above with reference to FIGS. 1 to 3.

FIG. 5 is a flow chart illustrating a cooperative data communication of a mobile device having multiple communication interfaces, the mobile device of which is described above with reference to FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the following description, a mobile device may include a mobile communication terminal.

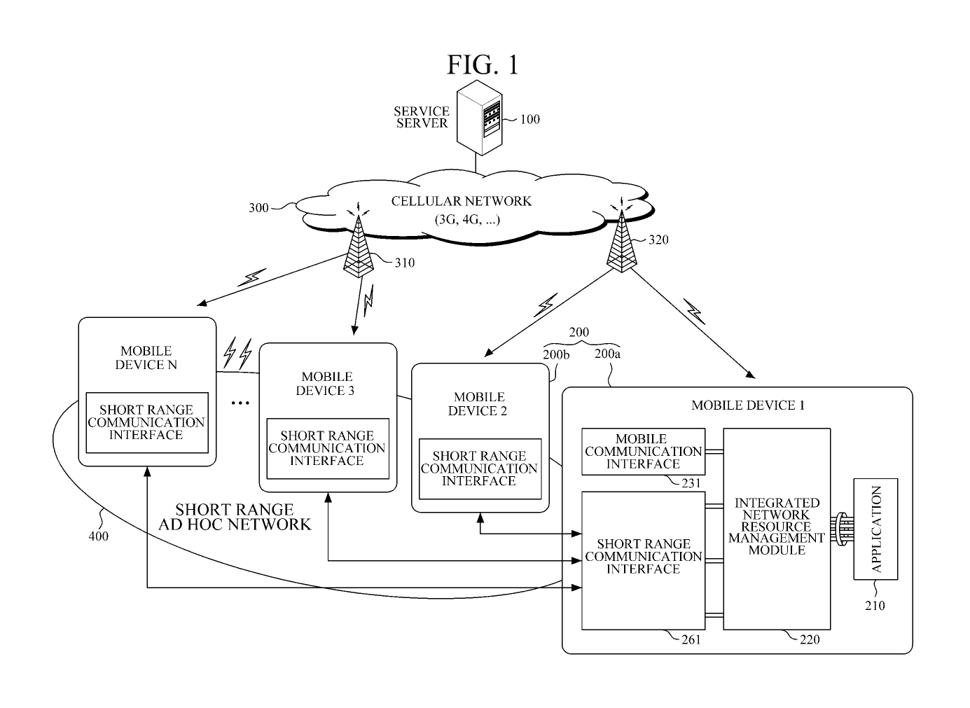

FIG. 1 is a diagram illustrating a configuration of a service system for explanation of a mobile communication device having a multiple communication interface and a cooperative data transmission method thereof, according to an exemplary embodiment. Referring to FIG. 1, a service system includes a service server 100, a plurality of mobile devices 200, and a cellular network 300 supporting communication among a plurality of mobile devices 200. In the service system, a plurality of mobile devices 200 has established or formed a short range ad hoc network 400.

Over the cellular network 300, the service server 100 provides content to a first mobile device 200a, which is one of a plurality of the mobile devices 200. Herein, providing content includes downloading content and streaming content in real time, but aspects of the present disclosure are not limited thereto. A service server providing a real-time stream service may be a stream service provider that is a kind of a communication service provider (CSP). The CSP may simultaneously provide stream services of various levels, such as high definition (HD) stream service and music file stream service.

To that end, the CSP may have a capability of controlling and managing network device. That is, the CSP may provide on-demand network capacity in response to a request from a user or an application. In addition, the CSP may adapt centralized network management to control and manage network devices more effectively.

The service server 100 may transmit the whole content to the first mobile device 200a having requested the service, or may divide content and a different portion of the divided content to each of the first mobile device 200a and the second to N-th mobile devices (Herein, ‘N’ indicates an integer number equal to or greater than 2). The second to N-th mobile devices are devices composing the short range ad hoc network 400 together with the first mobile device 200a, and may be one or more.

Given the above, content may be divided into two or more segments, and a different content segment may be transmitted to each of a plurality of mobile devices (that is, the first to N-th mobile devices) 200a and 200b. For example, one of the mobile devices 200 may request some content segments, and the service server 100 may transmit the requested content segments to the mobile device 200 requested the content segments. In another example, one of the mobile devices 200 receives in advance from the first mobile device 200a information on which mobile device is to receive which content segment, and the service server 100 may transmit content to each mobile device based on the received information.

Each of the mobile devices 200 is a user device that provides a mobile communication service. Each of the mobile devices 200 may have different names, such as a user equipment (UE), a mobile station (MS), or a device. Each of the mobile devices 200 supports communication conforming to one or more mobile communication standards, such as 2G, 3G, or 4G standard. In addition, each of the mobile devices 200 supports communication conforming to one or more short range communication standard. That is, each of the mobile devices 200 includes not only a mobile communication interface 231, but also one or more short range communication interfaces 261.

A typical example of the mobile devices 200 is a smart phone. Recently, s smart phone includes both the mobile communication interface 231, which utilizes merely the cellular network 300 for voice calls and data communication, and one or more short range communication interfaces 261 which utilize a short range communication network. Herein, short range communication includes Wireless Local Access Network (WLAN), Bluetooth, zigbee, and Near Field Communication (NFC), but the types of short range communication is not limited as long as it supports an ad hoc network that enables a plurality of the mobile devices 200 to communicate with one another. Each of the mobile devices 200 may include one or more short range communication interfaces 261, each of which supports the whole or part of the short range communication.

As having distance limitation, short range communication cannot be used for a distance greater than a predetermined numerical value, but it can support high transfer rate within a short range. In an exemplary embodiment of the present disclosure, such characteristics of short range communication are used to provide a service (e.g., a multimedia content downloading or stream service) requiring high transfer rate or a wide bandwidth by using cooperative communication between the mobile devices 200a and 200b. To that end, the mobile devices 200a and 200b placed within a short range, that is, within a communication distance supported by corresponding short range communication, establish a cooperative system by forming the short range ad hoc network 400 using a short range network function. Then, a specific mobile device, for example, the first mobile device 200a, which has bandwidth greater than that provided by the cellular network 300 or needs bandwidth that can be available using the cellular network 300, may receive a service with a wider bandwidth with help from different devices, that is, the second to N-th mobile devices 200b. At this point, the second to N-th mobile devices 200b transmits data, received over the cellular network 300, to the first mobile device 200a over the short range ad hoc network 400. Then, the first mobile device 200a combines data received over the short range ad hoc network 400 and data received directly over the cellular network 300, and transmits the combined data to an application.

As a result, the first mobile device 200a may receive a service of a high data transfer rate and a wider bandwidth from the service server 100. The first mobile device 200a is not required to do anything but receive part of content over a cellular network, thereby reducing costs and time for communication.

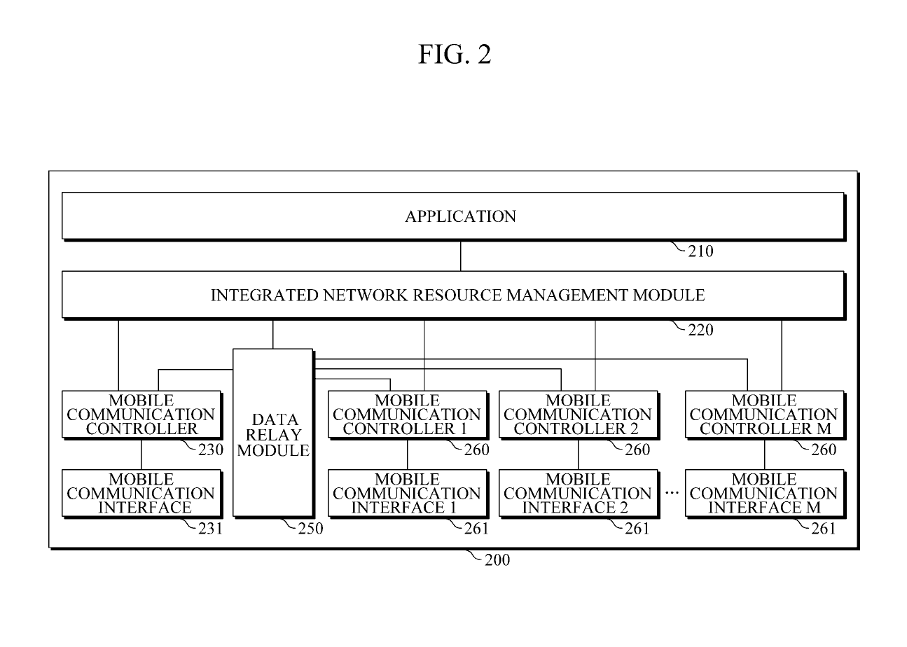

To this end, each of the mobile communication devices 200 includes the mobile communication interface 231 and one or more short range communication interfaces 261. In addition, each of the mobile communication devices includes an integrated network resource management module 220 and a data relay module 250 (See FIG. 2), all of which are described in detail in the following. For convenience of explanation, a configuration of the first mobile device 200a is illustrated in detail in FIG. 1, while a configuration of each of the different mobile devices 200b is illustrated simply.

The cellular network 300 aims to provide a mobile communication service, and a type or configuration of the cellular network 300 is not limited as long as it provides both a voice call service and a data communication service. For example, the cellular network 300 may not only be a cellular network conforming to the existing 2G, 3G, or 4G standard, but also may be the next generation mobile network that would provide a higher data transfer rate. Although FIG. 1 illustrates a case in which the cellular network 300 includes two base stations 310, and each of the base stations 310 communicates with one or more mobile devices 200, it is apparent for those skilled in the art that such a configuration is merely illustrative. For example, the whole or part of the other mobile devices 200b may communicate with the first mobile device 200a via the same base station 310 or a different base station 320. In addition, as long as the short range ad hoc network 400 is a short range communication network of the mobile devices 200, which enables the mobile device 200 to communicate directly with each other, there is no specific limitation on a configuration, a communication protocol, and a detailed procedure of forming an ad hoc network.

As illustrated in FIG. 1, a plurality of the mobile devices 200 have establishes the short range ad hoc network 400 according to a short range communication protocol, and each of the mobile devices 200 may receive and transmit data with respect to each other over the short range ad hoc network 400. A mobile device, for example, the first mobile device 200a, which wants to receive from the service server 100 a service requiring bandwidth greater than bandwidth that is available in the cellular network 300, is able to receive the service more smoothly using other mobile devices 200b in the short range ad hoc network 400.

Specifically, the first mobile device 200a divides a service (data) into a plurality of segments using the integrated network resource management module 220, distributes a plurality of segments only to available devices among the other mobile devices 200b, and requests transmission of some of the segments. Having received the request, each of the mobile devices 200b receives a data fragment directly from the cellular network 300, and transmits or relays the received data fragment to the first mobile device 200a over the short range ad hoc network 400. Then, the integrated network resource management module 220 of the first mobile device 200a uses a data relay module 250 (See FIG. 2) to combine data fragments (segments) received from the other mobile devices 200b and data fragments (segments) received directly over the cellular network 300, and then transmits the combined data to an application 210 that has requested the same.

Such cooperative communication allows the first mobile device 200a to use a service with bandwidth wider than cellular network bandwidth available for by the first mobile device 200a. For example, in a case where a number of people want to enjoy a live stream service requiring a high bandwidth (e.g., the World Cup, the Olympics, and other sporting events), and only Internet access over a cellular network is possible, a plurality of mobile devices may establish a short range ad hoc network so that a video stream service may be provided seamlessly over the cooperative communication. In another example, if a user wants to receive downloaded or streamed premium content, a plurality of mobile devices composing a short range ad hoc network distributedly receives corresponding content, so that both data transfer rate and costs may be reduced. In this case, if a mobile device with a sufficiently large idle data transfer capacity mainly utilized, it may be efficient to reduce costs for data transmission over the cellular network.

FIG. 2 is a block diagram illustrating a mobile devices illustrated in FIG. 1. Referring to FIG. 2, a mobile device 200 includes an integrated network resource management module 220 and a data relay module 250. In addition, the mobile device 200 includes a mobile communication interface 231, one or more short range communication interfaces 261 (the first to M-th short range communication interfaces, wherein M indicates an integer equal to or greater than 1), a mobile communication controller 230 for controlling each communication interface, and one or more short range communication controller 260 (the first to M-th short range communication controller, wherein M indicates an integer equal to or greater than 1). An application 210 illustrated in FIG. 2 is an application layer provided in the mobile device 200. Specifically, the application 210 indicates a module that requests necessary data from the integrated network resource management module 220, receives data received from the integrated network resource management module 330, and uses (which means playing back or implementing) the received data.

The integrated network resource management module 220 is between the application 210 and network resources, and configured to manage and control sub network resources to support network resources necessary for the application 210. The network resources includes the mobile communication interface 231 and the mobile communication controller 230 that controls operations of the mobile communication interface 231. In addition, the network resources further includes one or more short range communication interfaces 261, that is, the first to M-th short range communication interfaces 261, and the first to M-th short range communication controllers 260, which are configured to control operations of the respective short range communication interfaces 261. The number of short range communication interfaces 261 varies depending on functions of each device. Each of the network resources is controlled by the integrated network resource management module 220. That is, by controlling operations of the mobile communication controller 230 and the short range communication controller 260, the integrated network resource management module 220 may control operations of the mobile communication interfaces 231 and the short range communication interfaces 261. It means that operations of each of the communication interfaces 231 and 261 may be controlled by the integrated network resource management module 220.

In response to a data request from the application 210, the integrated network resource management module 220 divides the requested data into a plurality of segments for more efficient receipt of the requested data from a service server (the service server 100, see FIG. 1). That is, the integrated network resource management module 220 plans a strategy to receive requested data using all available network resources, and transmits a data request for each data fragment to the mobile communication interfaces 231 or the first to M-th short range communication interfaces 261.

To this end, the integrated network resource management module 220 may in advance receive information on the requested data from the application 210 or information on the requested data received from the service server (the information that is metadata of corresponding data). In addition, the integrated network resource management module 220 divides the requested data using not just information on available bandwidth for itself over the mobile communication interface 231, but also a list of different mobile devices in a short range ad hoc network and information on available bandwidth of each of the different mobile devices. To this end, the integrated network resource management module 220 monitors a list of different mobile devices in a short range ad hoc network and information on bandwidth of each of the different mobile devices, or requests and receives necessary information from each of the different mobile devices when necessary.

The data relay module 250 transmits or relays signals and data between configuration elements of the mobile device 200. Specifically, the data relay module 250 may transmit various signals (request messages) between the integrated network resource management module 220, the mobile communication interfaces 231, and the first to M-th short range communication interfaces 261, and may transmit data received from each of the communication interfaces 231 and 261. In addition, the data relay module 250 may incorporate or combine data fragments received from each of the communication interfaces 231 and 261 to generate necessary data, and transmit the generated data to the application 210.

For example, the data relay module 250 may transmit to the integrated network resource management module 220 a service request received from a different mobile device composing the short range ad hoc network 400 (See FIG. 1). The integrated network resource management module 220 may control the mobile communication interfaces 231 to receive data over a cellular network (the cellular network 300, See FIG. 1) in response to a received service request. In addition, the data relay module 250 may transmit to the short communication interfaces 261 the data received from the mobile communication interfaces 231. Then, the integrated network resource management module 220 controls the short range communication interfaces 261 to transmit the received data to a device, which has requested the same data, over the short range ad hoc network 400, so that the received data may be transmitted to a different mobile device, that is, the device that has requested the same, in the short range ad hoc network 400.

In another example, in accordance with control of the integrated network resource management module 220, a data request may be transmitted by the data relay module 250 to each of the mobile communication interfaces 231 and the short range communication interfaces 261. Herein, the short range communication interfaces 261 are short range communication interfaces that have established an ad hoc network together with different mobile devices. The data request transmitted to the short range communication interfaces 261 is transmitted to different mobile devices in the ad hoc network. In accordance with the data request, requested data is received via each of the mobile communication interfaces 231 and the short range communication interfaces 261. Herein, data received via the short range communication interfaces 261 is data received over the short range ad hoc network, which was received by the different mobile devices over a cellular network. The data relay module 250 integrates or combines data received from each of the mobile communication interfaces 231 and the short range communication interfaces 261, and the combined data may be transmitted to the application 210 in accordance with control of the integrated network resource management module 220.

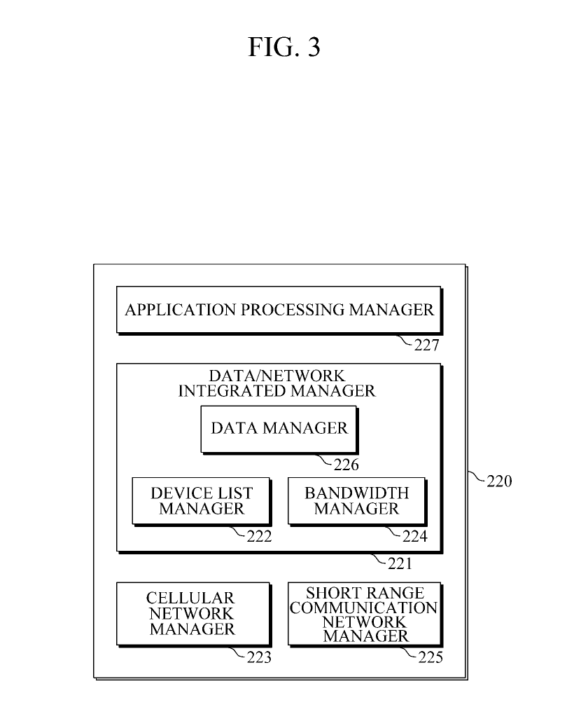

FIG. 3 is a diagram illustrating a detailed configuration of an integrated network resource management module shown in FIG. 2. Referring to FIG. 3, an integrated network resource management module 200 includes a data/network integration manager 221, a cellular network manager 223, a short range communication network manager 225, and an application processing manager 227. In addition, the data/network integration manager 221 includes a data manager 226, a device list manager 222, and a bandwidth manager 224.

The application processing manager 227 is responsible for classifying, processing, and managing requests from applications within a device. That is, the application processing manager 227 manages a plurality of applications using a network sharing function in a device and processes requests from each application.

In response to a request from the application processing manager 227, the data manager 226 of the data/network integration manager 221 separates/integrates data required by an application. Specifically, the data manager 226 analyzes content (data) requested by the application processing manager 227, and calculates network demands required for processing the content (that is, a process for downloading the data). Then, based on the analyzed content, the data manager 226 requests a device list manager 222 and a bandwidth manager 224 to receive data. Having received data in response to the request, the data manager 226 combines the received data, so that the combined data may be transmitted to an application via the application processing manager 227.

The device list manager 222 monitors and manages a list of devices composing a short range ad hoc network and availability of a cellular network. Specifically, the device list manager 222 manages a list of devices composing a short range ad hoc network to collect information on available bandwidth of each of the devices. To this end, the device list manager 222 is able to constantly monitor not just a configuration of each of the devices composing a short range ad hoc network, but also a network state of each of the devices.

In addition, the device list manager 222 may manage cooperation history of each of the mobile devices forming the short range ad hoc network, as well as a list of the mobile devices. Herein, the cooperation history may include information on bandwidth, which was previously provided for a purpose of cooperative communication between the devices. Along with information about interworking of a frequently-used short range ad hoc network and information on bandwidth of each device, the cooperation history may be used to manage previous history, so that it may be possible to distribute bandwidth and utilize devices more rapidly in the next round of cooperation.

The bandwidth manager 224 monitors available bandwidth (that is, bandwidth available in a cellular network) of each of the mobile devices, which are included in the list managed by the device list manager 222, and distributes bandwidth in response to a request. For the distribution of bandwidth, the bandwidth manager 224 may analyze the monitored available bandwidth and determines, based on the analysis result, which bandwidth is to be requested by each of the mobile devices. The information about bandwidth, determined in this manner, is transmitted to the data manager 226 to be used when dividing the entire data, which is requested, into data fragments that are to be requested from the mobile devices.

The cellular network manager 223 transmits and receives data over a cellular network currently accessed by a mobile device. To this end, the cellular network manager 223 is able to control operations of the mobile communication interfaces 231 (See FIG. 2). The short range communication network manager 225 is responsible for short range communication over a short range ad hoc network. For the short range communication, the short range communication network manager 225 is able to control operations of the short range communication interfaces 261 (See FIG. 2). In this embodiment, the short range communication network manager 225 may control operations of one or more short range communication interfaces, that is, communication over a plurality of short range ad hoc networks, according to performance and other conditions of a mobile device.

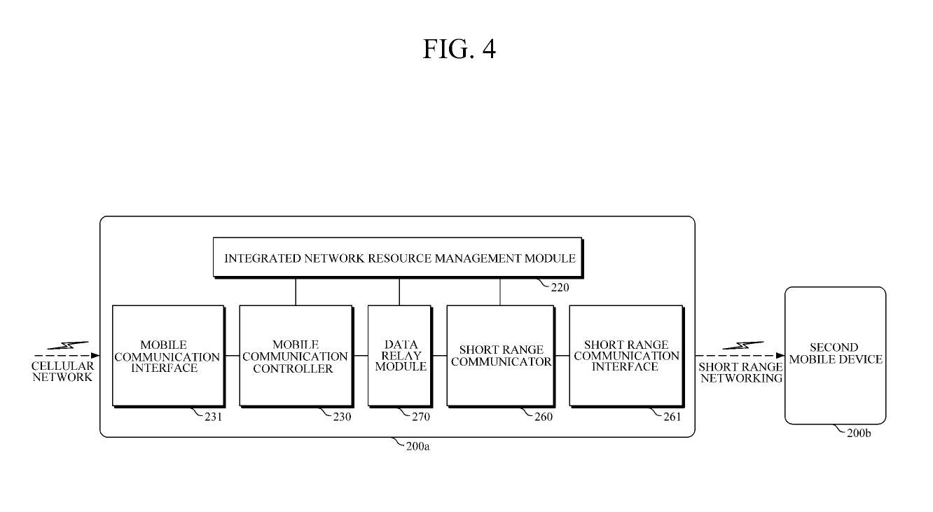

FIG. 4 is a diagram illustrating a cooperative data communication method of a mobile device having multiple communication interfaces, the mobile device of which is described above with reference to FIGS. 1 to 3. Hereinafter, with reference to FIG. 4, there are described two different cooperative data communication method: a cooperative data communication method of a first mobile device 200a using a second mobile device 200b, which has established the short range ad hoc network 400 (See FIG. 1) with the first mobile device 200a, and a cooperative data communication method of the first mobile device 200a shown in FIG. 1 in response to a request from a second mobile device 200b composing the short range ad hoc network 400. In the former method, there may be a plurality of the second mobile devices 200b, as described above.

First of all, there is provided descriptions of the cooperative data communication method of the first mobile device 200a using the second mobile device 200b composing the short range ad hoc network 400. In this case, the second mobile device 200b is a device that has established a short range ad hoc network with the first mobile device 200a for a purpose of a sharing network, and has available bandwidth in the cellular network 300. In response to a request for receipt of distributive data from the first mobile device 200, the second mobile device 200b receives requested data using available resources of a cellular network and transmits the received data to the first mobile device 200a.

In response to a request for receipt of data from an application, an integrated network resource management module 220 identifies both a list of different mobile devices 200b in the short range ad hock network and available network resources of each of the mobile device 200b. Then, in order to receive the requested data efficiently, an integrated network resource management module 220 plans to divide and receive the requested data. At this point, the whole data may be divided into the first data fragment to be received by a mobile communication interface 231 of the first mobile device 200a and the second data fragment to be received by one or more second mobile devices 200b in the short range ad hock network. In a case where there is a plurality of second mobile devices 200b in the short range ad hock network, the second data fragment may be divided into sub data fragment to be assigned to each of the second mobile devices 200b.

Then, the integrated network resource management module 220 controls operations of the mobile communication interface 231 to receive the first data fragment over a cellular network. To that end, the integrated network resource management module 230 transmits a request for receipt of the first data fragment to the mobile communication controller 230 via a data relay module 270. The mobile communication interface 231 transmits the request for receipt of the first data fragment to a server over a cellular network, and then receives the first data fragment over the cellular network in response to the request. The mobile communication interface 231 transmits the received first data fragment to the data relay module 270.

In addition, the integrated network resource management module 220 controls operations of a short range communication interface 261 to receive the second data fragment over a short range ad hoc network. To this end, the integrated network resource management module 230 transmits a request for receipt of the second data fragment to the short range communication controller 260 via the data relay module 270. In a case where there is a plurality of the second mobile devices 200b in the short range ad hock network, the integrated network resource management module 230 may transmit a request for receipt of each sub data fragment to the short range communication controller 260. The short range communication interface 261 transmits the request for receipt of the second data fragment (or each sub data fragment) to the second mobile device 200b over the short range ad hock network, and receives the second data fragment (or each sub data fragment) in response to the request. Then, the short range communication interface 261 transmits the received second data fragment (or each sub data fragment) to the data relay module 270.

Then, the data relay module 270 combines the first data fragment received from the mobile communication interface 231 and the second data fragment (a plurality of sub data fragments) received from the short range communication interface 261. The combined data is transmitted via the integrated network resource management module 220 to the application that has requested the same.

Next, there is described a cooperative data communication method of the first mobile device 200a shown in FIG. 1 in response to a request from the second mobile device 200b in the short range ad hoc network 400. In this case, the first mobile device 200a is a device that has established a short range ad hock network with the second mobile device 200b for a purpose of a shared network, and has available cellular network bandwidth. In response to a request for receipt of distributive data from the second mobile device 200b, the first mobile device 200a receives the requested data using available cellular network resources and transmits the received data to the second mobile device 200b. The method described herein may be a procedure performed by the second mobile device 200b after receiving a request for transmission of the second data fragment.

The short range communication interface 261 of the first mobile device 200a receives a request for transmission of data from the second mobile device 200b over a short range ad hoc network. The request for transmission of data aims to receive the second data fragment described above or a sub data fragment that is a piece of the second data fragment from the second mobile device 200b. Then, the short range communication interface 261 transmits the received request for transmission of data to the integrated network resource management module 220 via the data relay module 270. The integrated network resource management module 220 analyzes and transmits the received request for transmission of data, and receives the requested data over a cellular network. The integrated network resource management module 220 transmits the data, received from the mobile communication interface 231, to the short range communication interface 261 via the data relay system 270, so that the data may be transmitted to the second mobile device 200b.

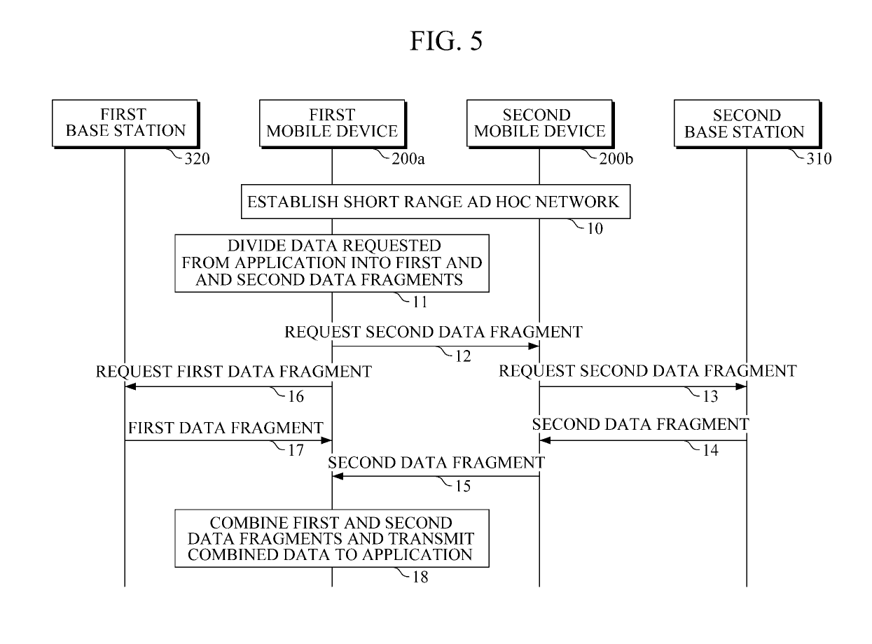

FIG. 5 is a flow chart illustrating a cooperative data communication of a mobile device having multiple communication interfaces, the mobile device of which is described above with reference to FIG. 4. FIG. 5 relates to a case where the first mobile device 200a cooperates with a different device, that is, the second mobile device 200b, to receive necessary data. Hereinafter, the cooperative data communication method is described briefly with reference to FIG. 5, and descriptions provided above with reference to FIG. 4 may be applied herein, although they are not omitted in FIG. 5.

With reference to FIG. 5, the first mobile device 200a and the second mobile device 200b have established a short range ad hoc network that enables direct communication between the first and second mobile devices 200a and 200b in operation 10. As described above, there may be provided one or more second mobile devices 200b. In this embodiment, the procedure by which the devices 200a and 200b have established the short range ad hoc network is determined by a corresponding short range communication standard, and there is no specific limitation on the procedure. In addition, operation 10 may be performed before or after the first mobile device 200a receives a request for transmission of data from an application. Moreover, although not described in FIG. 5, the first mobile device 200a in the short range ad hoc network may collect information on the number of the second mobile devices 200b and on available bandwidth of each device.

Then, the first mobile device 200a divides data requested by an application into the first data fragment and the second data fragment in operation 11. In a case where there is a plurality of the second mobile devices 200b, the second data fragment may be divided into a plurality of sub data fragments, as described above. In operation 11, the first mobile device 200a may divide the requested data based on information on the number of second mobile devices and on information on bandwidth that can be provided by each device, wherein the information is collected and stored by the first mobile device 200a.

After operation 11, the first mobile device 200a requests and receives divided portions of data over both of the cellular network and the short range ad hoc network in operations 12 to 17. As operations 12 to 17 have been already described in detail, descriptions thereof are omitted herein. There is no specific limitation on timing of performing operations 16 and 17 and operations 12 to 15: operations 16 and 17 are operations in which the first mobile device 200a requests and receives the first data fragment from the first base station 320 over a cellular network, and operations 12 to 15 are operations in which the first mobile device 200a requests the second data fragment from the second mobile device 200b over a short range ad hoc network, and the second mobile device 200b requests and receives the second data fragment from the second base station 310 over a cellular network. Thus, the timing of performing operations 12 to 17 in FIG. 5 is merely exemplary. For example, contrary to the example of FIG. 5, operation 16 may be performed simultaneously with or before operation 12, and the timing of performing operations 15 and 17 may be changed.

Having received the first data fragment from the first base station 320 and the second data fragment from the second mobile device 200b after operations 12 to 17, the first mobile device 200a incorporates or combines the received first and second data fragments in operation 18. The combined data is transmitted to the application that has requested the same.

In this embodiment, by utilizing cooperative communication between devices in a short range ad hoc network, a mobile device may utilize a service requiring bandwidth greater than limited bandwidth that is available or assigned to itself in a cellular network. In particular, the mobile device may receive a download or stream service for high-quality multi-media simply by using limited cellular network bandwidth. In addition, the mobile device is able to tap into resources of a different mobile device having idle bandwidth (or data transfer capacity), so that it may receive a download or stream service more economically.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile device having multiple communication interfaces to receive data transmitted from a service server, the mobile device comprising:
a mobile communication interface configured to perform data communication over a cellular network;
one or more short range communication interfaces, each of which is configured to establish a short range ad hoc network with one or more different mobile devices and communicate with the different mobile devices over the short range ad hoc network;
an integrated network resource management module configured to control the mobile communication interface and the one or more short range communication interfaces; and
a data relay module configured to enable data transmission between the mobile communication interface, the one or more short range communication interfaces, and the integrated network resource management module,
wherein the integrated network resource management module is further configured to divide the data into first data fragment and second data fragment, control the mobile communication interface to receive the first data fragment over the cellular network, and control the one or more short range interfaces to receive the second data fragment over the short range ad hoc network.

2. The mobile device of claim 1, wherein the integrated network resource management module is further configured to divide the data based on a number of different mobile devices in the short range ad hoc network and on available bandwidth provided by each of the different mobile devices over the cellular network.

3. The mobile device of claim 2, wherein the integrated network resource management module is further configured to comprise:
a device list manager configured to manage information on the different mobile devices; and
a bandwidth manager configured to manage information on the available bandwidth provided by each of the different mobile devices over the cellular network, wherein the different mobile devices are managed by the device list manager.

4. The mobile device of claim 1, wherein the integrated network resource management module is further configured to comprise:
a mobile communication manager configured to manage operations of the mobile communication interface; and
a short range communication network manager configured to manage operations of the one or more short range communication interfaces.

5. The mobile device of claim 1, wherein the data relay module is further configured to combine the first data fragment and the second data fragment, and transmit the combined data to an application.

6. The mobile device of claim 1, wherein in a case where there is a plurality of different mobile devices in the short range ad hoc network, the integrated network resource management module is further configured to divide the second data fragment into a plurality of sub data fragment and control the one or more short range communication interfaces to receive the plurality of sub data fragment over the short range ad hoc network.

7. The mobile device of claim 1, wherein in response to a request for receipt of data from the second mobile device over the short range ad hoc network, the integrated network resource management module is further configured to control the mobile communication interface to receive the requested data over the cellular network and transmit the requested data to the second mobile device over the short range ad hoc network.

8. The mobile device of claim 7, wherein the data relay module is further configured to transmit the requested data to the short range communication interfaces.

9. A cooperative communication method of mobile devices, each having a mobile communication interface and one or more short range communication interfaces, the method comprising:
dividing data requested by an application into first data fragment to be received using the mobile communication interface, and second data fragments to be received using the one or more short range communication interfaces;
controlling the mobile communication interface to request transmission of the first data fragment from a service server, and controlling the one or more short range interfaces to request transmission of the second data fragments from different mobile devices that have established a short range ad hoc network with the mobile device; and
combining the first data fragment and the second data fragments, and transmitting the combined data fragment to the application.

10. The cooperative data communication method of claim 9, wherein an integrated network resource management module divides the data based on a number of different mobile devices in the short range ad hoc networks and information on available bandwidth provided by each of the different mobile devices over a cellular network.
